(19) United States
(12) Patent Application Publication
(10) Pub. No.: US 2010/0060871 A1
(43) Pub. Date: Mar. 11, 2010

(54) OFF-AXIS LIGHT SOURCE, LIGHT SCREEN PLATE, AND METHOD OF DEFINING DIFFERENT TYPES OF PATTERNS WITH SINGLE EXPOSURE

(75) Inventor: Yi-Shiang Chang, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Powership Semiconductor Corp., Hsinchu (TW)

(21) Appl. No.: 12/208,346

(22) Filed: Sep. 11, 2008

(51) Int. Cl. G03B 27/44; G03B 27/54

(52) U.S. Cl. 355/46; 355/67

(57) ABSTRACT

An off-axis light source is described, including an X-dipole illumination pattern, a Y-dipole illumination pattern and a quadrupole illumination pattern at the illumination surface thereof, wherein the illumination area of the quadrupole illumination pattern is smaller than that of the X- or Y-dipole illumination pattern. A light screen plate is also described, having corresponding openings therein and can be used to form the above off-axis light source. A method of defining different types of patterns with a single exposure is also described, which utilizes the above off-axis light source.

### BACKGROUND OF THE INVENTION

1. Field of the Invention

This invention relates to lithography process, and particularly relates to an off-axis light source, a light screen plate and a method of defining different types of patterns with a single exposure.

2. Description of Related Art

In current lithography process, the optimal settings of exposure parameters for different types of patterns are different, and the difference increases with the reduction of the process linewidth. Therefore, when different types of patterns are to be defined in the same film the double exposure technology is employed frequently, wherein two exposure steps are performed with different off-axis illumination shapes and different masks to define different types of patterns separately.

For example, in a memory lithography process with a linewidth below 50 nm wherein the memory cell area contains small-pitch dense line patterns having the critical dimension and the peripheral circuit area contains large-pitch dense line patterns and isolated line patterns, since the two areas differ greatly on the pattern size/direction, it is generally difficult to define all the patterns with a single exposure. Therefore, a double exposure process using different off-axis illumination shapes is required to define the circuit patterns in the memory cell area and those in the peripheral area separately.

Referring to FIG. 1, when the dense line pattern in the memory cell area extend in the X-direction, the suitable off-axis light source has a Y-dipole illumination pattern including two illumination regions 10 arranged in the Y-direction. For the peripheral circuit area including X- and Y-directional patterns, the suitable off-axis light source includes an annular illumination region 12. The illumination regions 10 or 12 can be formed simply by disposing a light screen plate with corresponding openings therein in front of the light source for exposure.

However, as the same pattern layer needs two masks and doubled exposure time, the double exposure method increases the mask cost and reduces the wafer throughput.

### SUMMARY OF THE INVENTION

Accordingly, this invention provides an off-axis light source, which is applicable to a method of defining different types of patterns with a single exposure.

This invention also provides a light screen plate for forming the off-axis light source of this invention.

This invention further provides a method of defining different types of patterns with a single exposure, which is implemented by using the off-axis light source of this invention.

The off-axis light source of this invention includes an X-dipole illumination pattern, a Y-dipole illumination pattern and a quadrupole illumination pattern at the illumination surface thereof. The illumination area of the quadrupole illumination pattern is smaller than that of the X- or Y-dipole illumination pattern.

In some embodiments, the X-dipole illumination pattern includes two first illumination regions arranged in the X-direction, the Y-dipole illumination pattern includes two second illumination regions arranged in the Y-direction, and the quadrupole illumination pattern includes four third illumination regions each located between one first illumination region and one second illumination region. An imaginary line from the center of any one of the third illumination regions to the center of the illumination surface forms an angle of about 45° with the X- or Y-axis of the illumination surface.

In an embodiment, the numerical aperture of the off-axis light source is between 0.65 and 1.30. When the radius of the illumination surface is normalized as 1, the distance from the center of the illumination surface to the outmost edge of any of the first or second illumination regions is between 0.50 and 0.98, the distance from the center of the illumination surface to the inmost edge of any of the first or second illumination regions is between 0.20 and 0.91, the spread angle of any of the first or second illumination regions toward the center of the illumination surface is between 10° and 70°, the distance from the center of any of the third illumination regions to the central Y-axis of the illumination surface is between 0.10 and 0.70, the distance from the center of any of the third illumination regions to the central X-axis of the illumination surface is between 0.10 and 0.70, and the radius of any of the third illumination regions is between 0.02 and 0.20.

The light screen plate of this invention is for forming the off-axis light source of this invention, having therein openings respectively corresponding to an X-dipole illumination pattern, a Y-dipole illumination pattern and a quadrupole illumination pattern. The total area of the openings corresponding to the quadrupole illumination pattern is smaller than that of the openings corresponding to the X- or Y-dipole illumination pattern.

In some embodiments, the openings corresponding to the X-dipole illumination pattern include two first openings arranged in the X-direction, the openings corresponding to the Y-dipole illumination pattern include two second openings arranged in the Y-direction, and the openings corresponding to the quadrupole illumination pattern include four third openings each located between one first opening and one second opening. An imaginary line from the center of any one of the third openings to the center of the light screen plate forms an angle of about 45° with the X- or Y-axis of the light screen plate.

In an embodiment, when the radius of the light shield is normalized as 1, the distance from the center of the light screen plate to the outmost edge of any of the first or second openings is between 0.50 and 0.98, the distance from the center of the light screen plate to the inmost edge of any of the first or second openings is between 0.20 and 0.91, the spread angle of any of the first or second openings toward the center of the light screen plate is between 10° and 70°, the distance from the center of any of the third openings to the central Y-axis of the light screen plate is between 0.10 and 0.70, the distance from the center of any of the third openings to the central X-axis of the light screen plate is between 0.10 and 0.70, and the radius of any of the third openings is between 0.02 and 0.20.

The method of defining different types of patterns with a single exposure of this invention including performing exposure by using the above off-axis light source of this invention and a single mask having the different types of patterns.

In some embodiments, the different types of patterns include X- or Y-directional dense patterns with a smaller pitch and X- and Y-directional patterns with a larger pitch. In an embodiment, the X- or Y-directional dense patterns include patterns in a memory cell area, and the X- and Y-directional patterns include patterns in a peripheral circuit area.

By employing the off-axis light source of this invention, the lithography process of one pattern layer needs a single exposure and one mask only. Thereby, as compared with the double exposure technique in the prior art, this invention can reduce the mask cost and increase the wafer throughput.

In order to make the aforementioned and other objects, features and advantages of this invention comprehensible, a preferred embodiment accompanied with figures is described in detail below.

### BRIEF DESCRIPTION OF THE DRAWINGS

FIG. 1 is a schematic view of two types of off-axis light sources used in a double exposure process in the prior art.

FIG. 2 is a schematic view of an off-axis light source or a light screen plate according to an embodiment of this invention.

FIG. 3 shows structural parameters of an off-axis light source or a light screen plate according to the embodiment of this invention.

### DESCRIPTION OF THE EMBODIMENTS

Referring to FIG. 2, a schematic view of an off-axis light source or a light screen plate according to the embodiment of this invention is shown.

The off-axis light source includes an X-dipole illumination pattern 210, a Y-dipole illumination pattern 220 and a quadrupole illumination pattern 230 at the illumination surface 200 thereof. The illumination area of the quadrupole illumination pattern 230 is smaller than that of the X-dipole illumination pattern 210 or the Y-dipole illumination pattern 220.

The X-dipole illumination pattern 210 includes two first illumination regions 212 arranged in the X-direction. The Y-dipole illumination pattern 220 includes two second illumination regions 222 arranged in the Y-direction. The quadrupole illumination pattern 230 includes four third illumination regions 232 each located between one first illumination region 212 and one second illumination region 222. The four third illumination regions 232 are preferably disposed symmetrically in the X-direction and Y-direction, that is, in a manner that an imaginary line from the center of any one of the third illumination regions 232 to the center of the illumination surface 200 forms an angle of about 45° with the X- or Y-axis of the illumination surface 200.

For the first to third illumination regions 212, 222 and 232, it is preferred that the area of each first illumination region 212 is equal to that of each second illumination regions 222 as well as each of the third illumination regions 232 has the same area.

Next, referring to FIG. 3, some structural parameters of the off-axis light source or the light screen plate according to the embodiment of this invention are shown. In this embodiment, the numerical aperture of the off-axis light source is between 0.65 and 1.30, preferably between 1.05 and 1.30. When the radius of the illumination surface 200 is normalized as 1, the distance R1 from the center of the illumination surface 200 to the outmost edge of any of the first illumination regions 212 or second illumination regions 222 is between 0.50 and 0.98, preferably between 0.85 and 0.96. The distance R2 from the center of the illumination surface 200 to the inmost edge of any of the first illumination regions 212 or the second illumination regions 222 is between 0.20 and 0.91, preferably between 0.64 and 0.768. The spread angle θ of any of the first illumination regions 212 or the second illumination regions 222 toward the center of the illumination surface 200 is between 10° and 70°, preferably between 30° and 40°. The distance pₓ from the center of any of the third illumination regions 232 to the central Y-axis of the illumination surface 200 is between 0.10 and 0.70, preferably between 0.40 and 0.60. The distance p_{y} from the center of any of the third illumination regions 232 to the central X-axis of the illumination surface 200 is between 0.10 and 0.70, preferably between 0.40 and 0.60. The radius r of any of the third illumination regions 232 is between 0.02 and 0.20, preferably between 0.06 and 0.10.

Further, the light screen plate of this embodiment has a structure corresponding to that of the above off-axis light source. Therefore, the light screen plate is also illustrated by FIG. 2 with the parts thereof indicated by the same reference numbers. Referring to FIG. 2, the light screen plate 200 has therein two first openings 212 corresponding to the X-dipole illumination pattern 210 and arranged in the X-direction, two second openings 222 corresponding to the Y-dipole illumination pattern 220 and arranged in the Y-direction, and four third openings 232 corresponding to the quadrupole illumination pattern 230. Thus, by disposing the light screen plate in front of an exposure light source like a laser, the aforementioned off-axis light source can be formed. In addition, the first openings 212, the second openings 222 and the third openings 232 are disposed in the same manner in which the first to third illumination regions 212, 222 and 232 are disposed. By replacing the terms “illumination surface” and “first/second/third illumination regions” in the above description about the structure of the off-axis light source with the terms “light screen plate” and “first/second/third openings” respectively, the arrangement of the openings is readily understood.

In order to show the effect of the off-axis light source or light screen plate of this invention, a computer simulation example is given below.

In this embodiment, the memory cell area includes X-directional dense line patterns with a line/space (L/S) width of 50 nm, and the peripheral circuit area includes X-directional dense line patterns with L/S=80 nm and Y-directional dense line patterns with L/S=80 nm. The exposure light is an azimuthally polarized light of 193 nm.

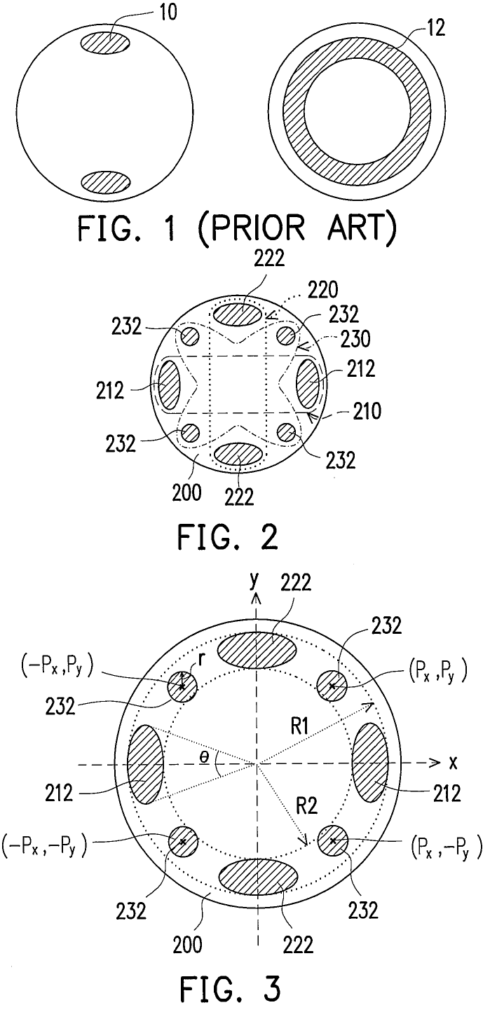

When NA=1.07 and the Y-dipole off-axis light source at the left of FIG. 1 is used for exposure, the contrast of the X-directional dense line patterns with L/S=50 nm is about 0.80 and the contrast of the X-directional dense line patterns with an L/S=80 nm is about 0.81, but the contrast of the Y-directional dense line patterns with L/S=80 nm is merely about 0.35 that is much smaller than 0.81. Accordingly, the Y-dipole off-axis light source is merely adapted to define patterns in the memory cell area. Further, when NA=0.90 and the annular off-axis light source at the right of FIG. 1 is used for exposure, the contrast of the X-directional dense line patterns with L/S=80 nm is equal to that of the Y-directional dense line patterns with L/S=80 nm (0.64), but the contrast of the X-directional dense line patterns with L/S=50 nm is zero. Accordingly, the annular off-axis light source is merely adapted to define patterns in the peripheral circuit area.

However, when NA=1.10 and the off-axis light source of this invention in FIG. 3 with the structural parameters R1=0.96, R2=0.768, θ=35°, pₓ=0.55, py=0.55 and r=0.08 is used for exposure, not only the X-directional dense line patterns with L/S=80 nm have the same high contrast (≈0.68) as that of the Y-directional dense line patterns with L/S=80 nm, but also the contrast of the X-directional dense line patterns with L/S=50 nm reaches 0.54 as an acceptable value. Accordingly, the off-axis light source of this invention is adapted to simultaneously define patterns in the memory cell area and those in the peripheral circuit area in a single exposure process.

By employing the off-axis light source of this invention, the lithography process of one pattern layer needs a single exposure and one mask only. Thereby, as compared with the double exposure technique in the prior art, this invention can reduce the mask cost and increase the wafer throughput.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. An off-axis light source, comprising an X-dipole illumination pattern, a Y-dipole illumination pattern and a quadrupole illumination pattern at an illumination surface thereof, wherein an illumination area of the quadrupole illumination pattern is smaller than an illumination area of the X- or Y-dipole illumination pattern.

2. The off-axis light source of claim 1, wherein the X-dipole illumination pattern comprises two first illumination regions arranged in an X-direction, the Y-dipole illumination pattern comprises two second illumination regions arranged in a Y-direction, and the quadrupole illumination pattern comprises four third illumination regions each located between one first illumination region and one second illumination region.

3. The off-axis light source of claim 2, wherein an imaginary line from a center of any one of the third illumination regions to a center of the illumination surface forms an angle of about 45° with an X- or Y-axis of the illumination surface.

4. The off-axis light source of claim 2, wherein a numerical aperture thereof is between 0.65 and 1.30, and when a radius of the illumination surface is normalized as 1,
a distance from a center of the illumination surface to an outmost edge of any of the first or second illumination regions is between 0.50 and 0.98;
a distance from the center of the illumination surface to an inmost edge of any of the first or second illumination regions is between 0.20 and 0.91;
a spread angle of any of the first or second illumination regions toward the center of the illumination surface is between 10° and 70°;
a distance from a center of any of the third illumination regions to a central Y-axis of the illumination surface is between 0.10 and 0.70;
a distance from the center of any of the third illumination regions to a central-X-axis of the illumination surface is between 0.10 and 0.70; and
a radius of any of the third illumination regions is between 0.02 and 0.20.

5. A light screen plate for forming an off-axis light source, comprising openings respectively corresponding to an X-dipole illumination pattern, a Y-dipole illumination pattern and a quadrupole illumination pattern, wherein a total area of the openings corresponding to the quadrupole illumination pattern is smaller than a total area of the openings corresponding to the X- or Y-dipole illumination pattern.

6. The light screen plate of claim 5, wherein the openings corresponding to the X-dipole illumination pattern comprise two first openings arranged in an X-direction, the openings corresponding to the Y-dipole illumination pattern comprise two second openings in a Y-direction, and the openings corresponding to the quadrupole illumination pattern comprise four third openings each located between one first opening and one second opening.

7. The light screen plate of claim 6, wherein an imaginary line from a center of any one of the third openings to a center of the light screen plate forms an angle of about 45° with an X- or Y-axis of the light screen plate.

8. The light screen plate of claim 6, wherein when a radius thereof is normalized as 1,
a distance from a center of the light screen plate to an outmost edge of any of the first or second openings is between 0.50 and 0.98;
a distance from the center of the light screen plate to an inmost edge of any of the first or second openings is between 0.20 and 0.91;
a spread angle of any of the first or second openings toward the center of the light screen plate is between 100 and 70°;
a distance from a center of any of the third openings to a central Y-axis of the light screen plate is between 0.10 and 0.70;
a distance from the center of any of the third openings to a central X-axis of the light screen plate is between 0.10 and 0.70; and
a radius of any of the third openings is between 0.02 and 0.20.

9. A method of defining different types of patterns with a single exposure, comprising performing exposure by using an off-axis light source and a single mask with the different types of patterns, wherein the off-axis light source comprises an X-dipole illumination pattern, a Y-dipole illumination pattern and a quadrupole illumination pattern on an illumination surface thereof, and an illumination area of the quadrupole illumination pattern is smaller than an illumination area of the X- or Y-dipole illumination pattern.

10. The method of claim 9, wherein the different types of patterns comprise X- or Y-directional dense patterns with a smaller pitch, and X- and Y-directional patterns with a larger pitch.

11. The method of claim 10, wherein the X- or Y-directional dense patterns comprise patterns in a memory cell area, and the X- and Y-directional patterns comprise patterns in a peripheral circuit area.

12. The method of claim 9, wherein the X-dipole illumination pattern comprises two first illumination regions arranged in an X-direction, the Y-dipole illumination pattern comprises two second illumination regions arranged in a Y-direction, and the quadrupole illumination pattern comprises four third illumination regions each located between one first illumination region and one second illumination region.

13. The method of claim 12, wherein an imaginary line from a center of any one of the third illumination regions and a center of the illumination surface forms an angle of about 45° with an X- or Y-axis of the illumination surface.

14. The method of claim 12, wherein a numerical aperture of the off-axis light source is between 0.65 and 1.30, and when a radius of the illumination surface is normalized as 1,
a distance from a center of the illumination surface to an outmost edge of any of the first or second illumination regions is between 0.50 and 0.98;
a distance from the center of the illumination surface to an inmost edge of any of the first or second illumination regions is between 0.20 and 0.91;
a spread angle of any of the first or second illumination regions toward the center of the illumination surface is between 10° and 70°;
a distance from a center of any of the third illumination regions to a central Y-axis of the illumination surface falls between 0.10 and 0.70;
a distance from the center of any of the third illumination regions to a central X-axis of the illumination surface is between 0.10 and 0.70; and
a radius of any of the third illumination regions is between 0.02 and 0.20.
